(19) United States
(12) Patent Application Publication
(10) Pub. No.: US 2004/0125022 A1
(43) Pub. Date: Jul. 1, 2004

(54) Antenna apparatus

(76) Inventors: Susumu Fukushima, Osaka (JP); Masahiro Yoshii, Gifu (JP)

Correspondence Address: WENDEROTH, LIND & PONACK, L.L.P., 2033 K STREET N. W., SUITE 800, WASHINGTON, DC, 20006-1021, US

(21) Appl. No.: 10/475,351

(22) PCT Filed: Nov. 18, 2002
(86) PCT No.: PCT/JP02/12004

(30) Foreign Application Priority Data
Dec. 28, 2001 (JP) 2001-400136

(51) Int. Cl. H01Q 1/38

(52) U.S. Cl. 343/700 MS; 343/846

(57) ABSTRACT

ABSTRACT In an antenna unit used for a radio communication device in mobile communications, the object of the present invention is to provide an easily portable antenna unit with low profile but high gain. Furthermore, the structure of the antenna unit can offer easy impedance-matching and maintain a preferable shape for the long term. In the antenna unit of the present invention, an opening is disposed in a part of a conductive material-made ground section made of conductive material. An antenna plate made of conductive material is disposed at the upper surface of the opening, while a ground plate made of conductive material is disposed at the upper section on the rear side of the opening. In addition, a radio frequency circuit is mounted on an area in a ground section other than the opening.

### TECHNICAL FIELD

The present invention relates to an antenna unit employed for communication equipment including small mobile devices and a card-type terminal for keyless entry system, and such communication equipment using the antenna unit.

### BACKGROUND ART

FIG. 9 shows a prior-art small compact antenna (disclosed in Japanese Patent Examined Publication No. H6-93635), which has been employed for mobile communication including a pager. Metal plate 101 serves as a ground plane that is an element of a micro-strip antenna. On metal plate 101, printed circuit board 105 having a circuit for wireless communication thereon is formed. Besides, conductor plate 102 is disposed on plate 101 via dielectric 104. The width of conductor plate 102 is sized narrower than that of metal plate 101. Metal plate 101 and conductor plate 102 are oppositely disposed. Dielectric 104 is sandwiched between plates 101 and 102.

Printed circuit board 105 is disposed on a section of plate 101 where conductor plate 102 does not face. Plates 101 and 102 mechanically and electrically connect, at each one end, with joint plate 103. The structure of square U-shaped plates 101, 102, and 103 forms a micro-strip antenna. The other ends of plates 101 and 102 are grounded via capacitor 106 so as to synchronize with a desirable frequency of the antenna. At the same time, impedance-matching has been optimized by determining an effective location of feeder section 107.

However, such structured micro-strip antenna has an antenna gain generally lower than that of a dipole antenna. For achieving higher antenna gain, it is necessary to keep the distance between conductive plate 102 and metal plate 101 as long as possible. Besides, to respond the demand for obtaining more compact antenna, the circuit-mounted area should be reduced to nearly half. That is, the radio frequency circuits should also be disposed on the lower surface of metal plate 101, as well as on the upper surface of it. As another inconvenience, forming the micro-strip antenna of a conductive plate has been an obstacle to achieving a metalworking and implementation with high dimensional accuracy in high volume production.

### DISCLOSURE OF THE INVENTION

The present invention addresses the problems above. It is therefore the object to provide an antenna unit not only having lower profile but higher gain, but also having a structure adaptable for mass production.

To achieve the object, in the structure of the antenna unit of the present invention, an opening is disposed in a part of the ground section made of a conductor, and an electrically conductive antenna plate is disposed on the upper section of the front surface of the opening. Besides, an electrically conductive ground plate is disposed on the upper section of the rear surface of the opening, and the radio frequency circuit or the like is disposed on a part—where the opening is not disposed—of the ground section.

### BRIEF DESCRIPTION OF THE DRAWINGS

FIG. 1A is an exploded perspective view of the antenna unit of a first embodiment.

FIG. 1B is an exploded sectional view of the antenna unit of the first embodiment.

FIG. 2 is a perspective view of an antenna model that is used for illustrating the technical advantages obtained from the antenna unit of the first embodiment.

FIG. 3 is a plot showing antenna characteristics that vary with the location of a second short-circuit section in the antenna unit of the first embodiment.

FIG. 4 is a plot showing antenna characteristics that vary with the location of a first short-circuit section in the antenna unit of the first embodiment.

FIG. 5A is a top view of the antenna unit of a second embodiment.

FIG. 5B is a sectional view of the antenna unit of the second embodiment.

FIG. 5C is a bottom view of the antenna unit of the second embodiment.

FIG. 6 is a top view of the antenna unit of a third embodiment.

FIG. 7A is an external view of communication equipment equipped with the antenna unit of the third embodiment.

FIG. 7B shows the state in which an operator uses the communication equipment having the antenna unit therein of the third embodiment.

FIG. 8A shows a radiation pattern when a first conductor layer serves as an antenna in the antenna unit of the third embodiment.

FIG. 8B shows a radiation pattern when a generally linear conductor element serves as an antenna in the antenna unit of the third embodiment.

FIG. 9 shows a schematic view of a conventional antenna unit.

### DETAILED DESCRIPTION OF CARRYING OUT OF THE INVENTION

Hereinafter, the antenna unit of the present invention is described in the embodiments below.

First Exemplary Embodiment

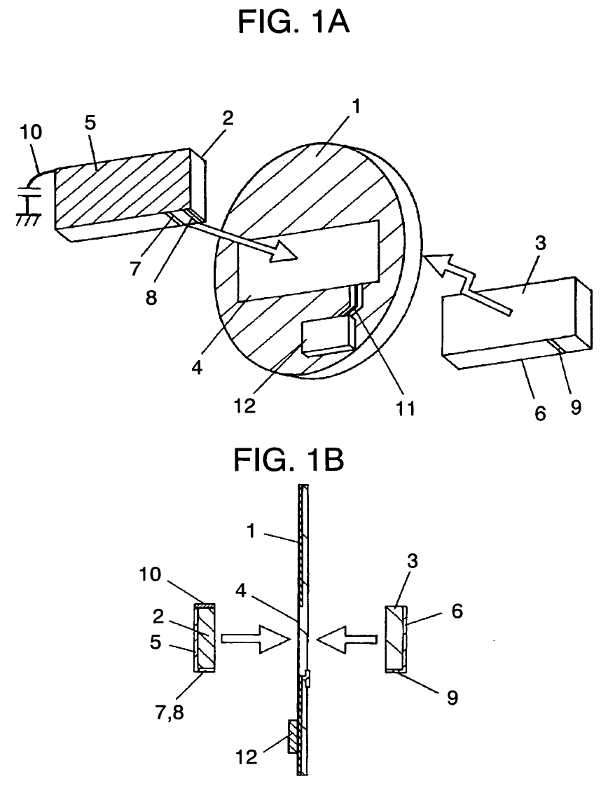

The structure of the antenna unit of the first embodiment of the present invention is described hereinafter with reference to the accompanying drawings, FIG. 1A and FIG. 1B.

Conductive material-made ground layer 1 is formed on the surface of first substrate 100. Ground layer 1 has opening 4 at a part of its surface, that is, ground layer 1 has no conductivity at the part. Insulating resin-made second substrate 2 is disposed over one side of opening 4 on substrate 100. Third substrate 3, which is also made of insulating resin, is disposed opposite to the second substrate 2 through substrate 100. On the surface of second substrate 2, first conductor layer 5 is disposed so as to serve as an antenna plate. On the other hand, on the surface of third substrate 3, second conductor layer 6 is disposed so as to serve as a part of a ground plate. First feeder section 7 and first short-circuit section 8 are formed on second substrate 2. In feeder section 7, one end of it is connected to conductor layer 5; in first short-circuit section 8, one end of it is also connected to conductor layer 5, while the other end is connected to ground layer 1. Besides, substrate 2 couples capacitor 10 that is located nearly diagonal to feeder section 7 and is connected to both first conductor layer 5 and ground layer 1. Second short-circuit section 9 is disposed on third substrate 3. One end of second short-circuit section 9 is connected to second conductor layer 6, and the other end is connected to ground layer 1 via ground short-circuit through-hole 16 in first substrate 100. Through-hole 16 is formed by machining processes, such as punching and drilling, and then the machined through-hole is filled with conductive material. The conductive material in the through-hole is electrically insulated from ground layer 1 on first substrate 100. For each substrate above, a commercially available circuit board given patterning and necessary treatment can be employed. As to each conductive layer, foil typified by copper foil or a deposited metal layer can be employed. The short-circuit section and the feeder section are formed of conductive paste or metallic powder or the like. Each conductor layer and the short-circuit section, or each conductor layer and the feeder section is soldered to connect each other. Joint by electrically conductive paste can be an alternative to the soldered joint.

As an advantage of the antenna unit of the invention, employing third substrate 3 increases the distance from conductor layer 5 serving as the antenna plate to second conductor layer 6 serving as the ground plate. That is, the increased distance between the antenna plate and the ground plate can offer higher radiant gain and broader bandwidth.

In the structure above, first feeder section 7 is situated at a position generally having high electric-field strength between first and second conductor layers. As another advantage, loading capacitance to a position diagonal to feeder section 7 allows the capacitance loaded to get lowered; accordingly, loss of load capacity can be minimized.

Metal plates, which has been conventionally used for the material of an antenna, are hard to machine and hard to maintain the shape of the antenna. Whereas in the present invention, the substrates used for the antenna are made of electrically insulating resin, which contributes to an easy machining and constantly maintained antenna shape. Besides, impedance matching of the antenna can be performed by changing relative permittivity, tanδ, of the insulating resin-made substrate used for the antenna.

The substrates used for second substrate 2 and third substrate 3 are not required to have the same tans and the same relative permittivity. For matching impedance of the antenna unit, a plurality of third substrates 3, each of which has differently positioned second short-circuit section 9, should preferably be prepared in advance. Attaching each substrate individually on opening 4 can facilitate an easy and quick impedance-matching. As another plus, changing the position of second short-circuit 9 can also vary the radiation pattern of the antenna unit. Therefore, the optimum radiation pattern with respect to the wave conditions for the location of the antenna unit can be easily selected.

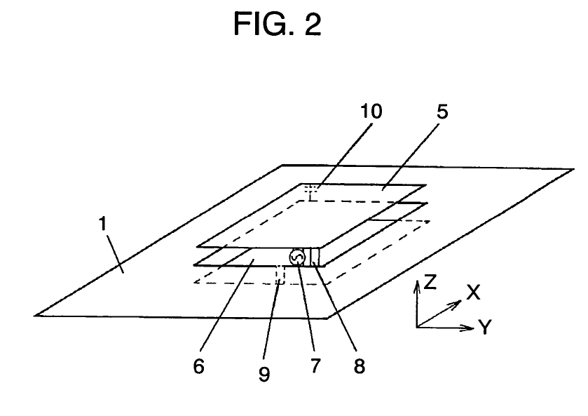

FIG. 2 shows the antenna model used for showing characteristics of impedance and the radiation pattern that vary with changing position of second short-circuit section 9 of the antenna unit. In the model, first conductor layer 5 and second conductor layer 6 for the antenna plate have the size of 30 mm by 30 mm; first feeder section 7, first short-circuit section 8, and second short-circuit section 9 are of 2 mm length each.

Ground layer 1 with the size of 80 mm square has opening 4 of 30 mm square in its center. The second and the third substrates are fixed so as to sandwich opening 4 of first substrate 100 therebetween. As a result, first conductor layer 5 and second conductor layer 6 are oppositely arranged via first substrate 100 in the vertical direction in FIG. 2. In the antenna model, the position of second short-circuit section 9 was varied as follows:

Position in case (a): just under first short-circuit section 8

Position in case (b): just under first feeder section 7

Position in case (c): just under the position 1 mm-away from first feeder section 7 in the opposite direction to first short-circuit section 8

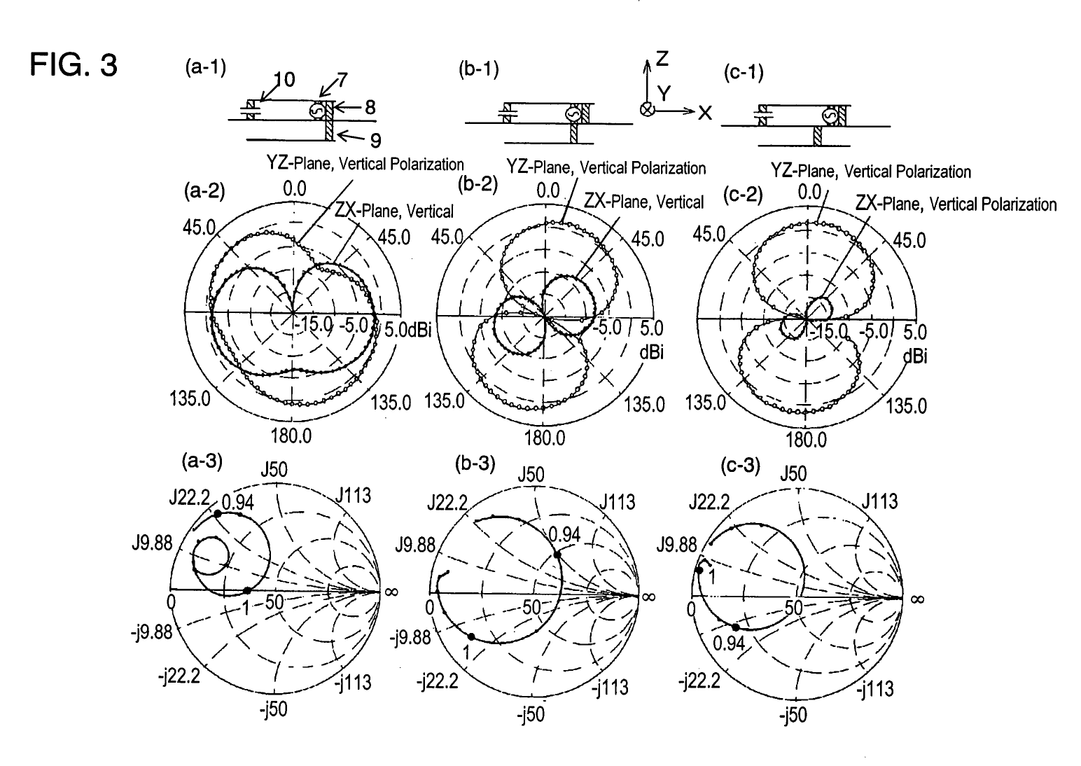

FIG. 3 shows the position-to-position measurement results of changes in characteristics of impedance and radiation pattern.

In the impedance characteristics, a circular path on Smith Chart changes its size from (a-3) through (b-3) to (c-3) as the position of second short-circuit section 9 varies from case (a) through (b) to (c), and accordingly, there are significant differences in resonance frequency corresponding to each case. On the other hand, in the radiation characteristics, it will be noted that case (a) offers a high antenna gain along the X-axis or the Y-axis, while case (c) offers the high antenna gain along the Z-axis. That is, the antenna gain can be easily controlled by changing the position of second short-circuit section 9.

Although the first embodiment demonstrates that the characteristics of impedance and radiation pattern can be controlled by the structure in which a single short-circuit section is disposed, it is not limited thereto; the same effect can be obtained by the structure having a plurality of short-circuit sections.

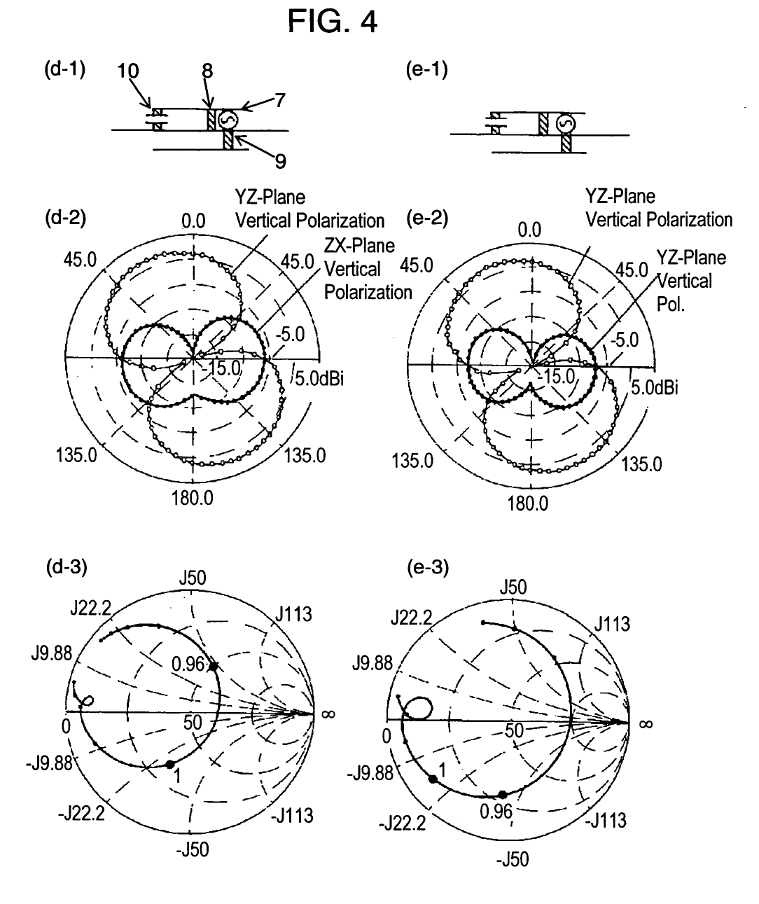

FIG. 4 shows the changes in the characteristics of impedance and the radiation pattern when the position of first short-circuit section 8 moves from position (d) to position (e):

Position in case (d): the position 1 mm-away from first feeder section 7

Position in case (e): the position 2 mm-away from first feeder section7

Although a significant difference between the positions above is not observed, the size of the circular path on Smith Chart can be changed. It will also be noted that resonance frequency can be controlled.

In other words, locating the short-circuit section 8 close to first feeder section 7 allows the antenna unit to have an optimal condition without the need for an additional matching circuit.

Although the first conductor layer of the first embodiment is formed into a flat square, it is not limited thereto; a structure having any given edges in which given number of slits are disposed is also effective in impedance matching of the antenna unit.

Second Exemplary Embodiment

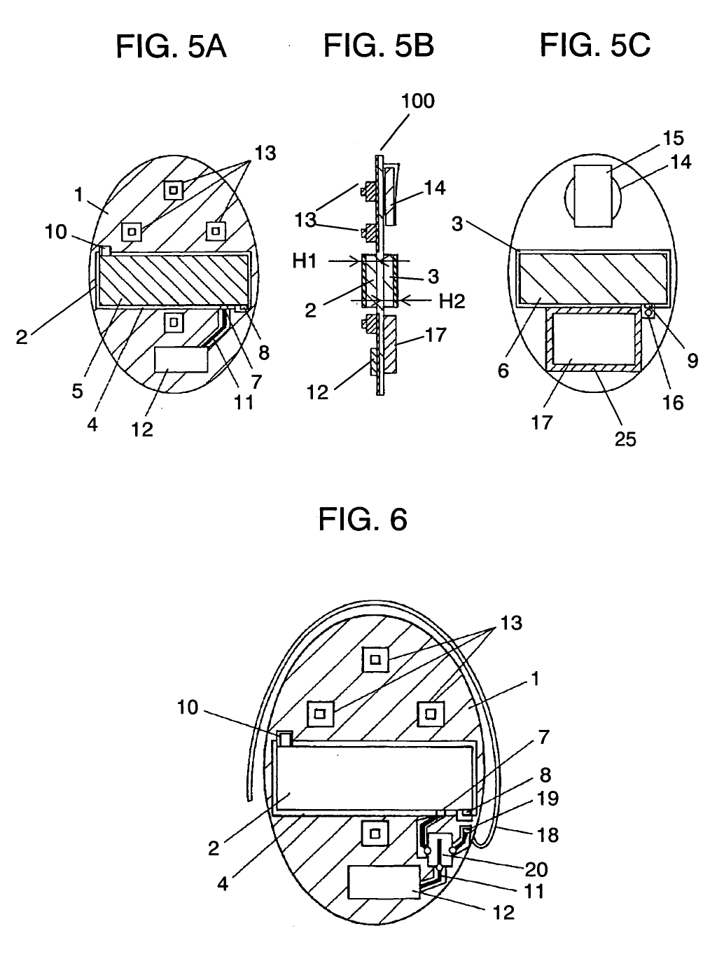

The second embodiment of the present invention is described with reference to FIG. 5. FIG. 5A shows a top view (i.e., the first surface) of the antenna unit; FIG. 5B shows a sectional view of the unit; and FIG. 5C shows a bottom view (i.e., the second surface) of the unit. Reference marks “H1” and “H2” indicate the thickness of second substrate 2 and third substrate 3, respectively. Mechanical switches 13 and first radio-frequency circuit 12 are disposed in the area other than opening 4 on the top surface of ground layer 1. First radio-frequency circuit 12 connects to first feeder section 7 through feeder line 12.

On the other hand, in the area—other than opening 4—on the bottom surface of ground layer 1, battery 14, battery-fixing jig 15, and second radio-frequency circuit 17 are disposed. Second radio-frequency circuit 17 is disposed on second ground layer 25 that is attached to the rear surface of first substrate 1. First radio-frequency circuit 12 and second radio-frequency circuit 17 are connected via a conductive through-hole (not shown) that runs through first substrate 1.

As shown in FIG. 5B, arranging components with a length less than aforementioned H1 and H2, which indicate the thickness of second substrate 2 and third substrate 3, respectively, allows the project area for the antenna unit to reduce to almost one-half. It is therefore possible to provide an antenna unit with lower profile but still higher gain.

Third Exemplary Embodiment

The third embodiment will be described with reference to FIG. 6. In FIG. 6, generally linear conductor element 18 is disposed so as to generally surround the circumference of ground layer 1; one end of element 18 is connected to antenna selector switch 20 via second feeder section 19; and first feeder section 7 is also connected to antenna selector switch 20. Such structured antenna unit is switch-selectable according to environmental conditions.

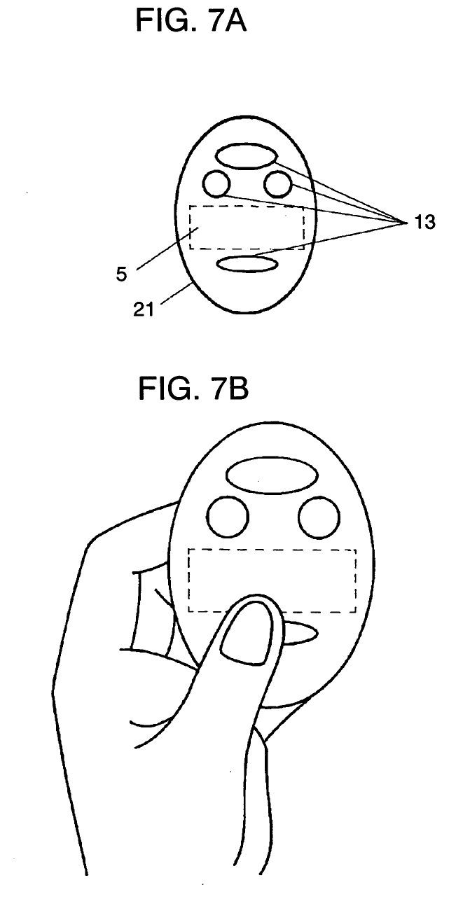

FIG. 7A is an external view of communication equipment equipped with the antenna unit of the present invention. Mechanical switches are disposed on the ground section of first substrate 100. The outside of the communication equipment is covered with insulating resin-made cover 21 other than areas corresponding to the mechanical switches; cover 21 is perforated with holes at areas having mechanical switches 13, thereby an operator can operate the switches from outside. FIG. 7B shows the state in which an operator operates the equipment by the fingers.

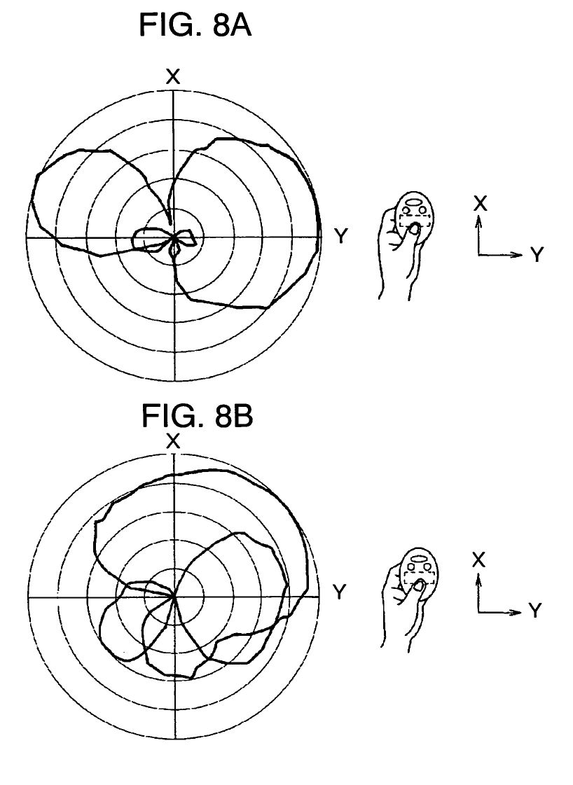

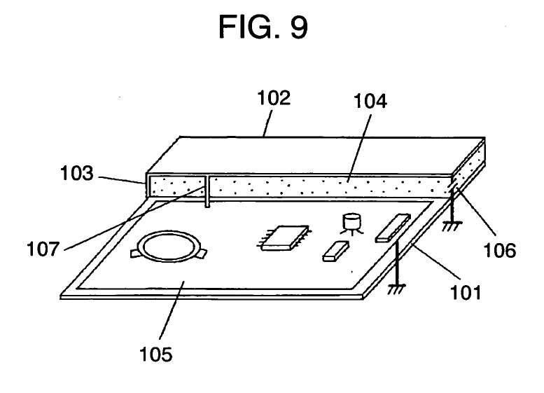

FIG. 8A shows a radiation pattern when first conductor layer 5 shown in FIG. 7B serves as an antenna in the antenna unit of the third embodiment. When an operator pushes a mechanical switch by a finger to activate the equipment, a null point of the radiation pattern appears in a direction of X-axis —a direction in the front of the operator. If the operator has a communicating partner in the direction, communication quality can be significantly degraded. However, in the communication equipment shown in FIG. 7B, the operator can switch the operating state so that generally linear conductor element 18 alone works as the antenna, thereby increasing the antenna gain along the X-axis (in a direction in the front of the operator). FIG. 8B shows a radiation pattern when generally linear conductor element 18 alone serves as the antenna. As is apparent from the figure, a sufficient amount of the antenna gain along the X-axis can be obtained by switching antenna with the antenna selector switch.

As described above, employing the generally lineal conductor element for the antenna can increase the poor radiant gain obtained by the first conductor layer serving as the antenna. Therefore, communication devices equipped with such antenna can achieve communication with high quality, regardless of how the equipment is oriented.

Besides, the structure of the present invention allows the antenna to be selectable between the generally linear conductor element and the first conductor layer; the conductor element can offer desirable radiation pattern in finger-operation of the mechanical switch, while the first conductor layer can offer excellent antenna characteristics in the cases in which the equipment is being put in the operator's chest pocket, or the equipment is kept close to a cigarette case. Such an antenna-selectable function can contribute to an antenna unit with consistent communication quality in various operating environments without serious degradation in performance.

### INDUSTRIAL APPLICABILITY

According to the present invention, as described above, the antenna unit, which is built-in mobile devices including identification (ID) card and a pager, not only achieves desirable characteristics with higher gain and broader range, but also offers easy and quick impedance-matching. Besides, the structure has less deformation in its shape due to aging, thereby providing a long-term durability with high quality.

1. An antenna unit comprising:
an insulating first substrate having a first surface and a second surface that is disposed on an opposite side of the first surface;
a conductive first ground layer with an opening having a determined shape disposed on the first surface of the first substrate;
a first conductor layer that is shaped generally identical to the opening and is oppositely spaced to the first surface at the opening;
a second conductor layer that is shaped generally identical to the opening and is oppositely spaced to the second surface on a side of a rear surface of the opening;
a first feeder section made of a strip-shaped conductor that connects to the first conductor layer;
a first short-circuit section made of a strip-shaped conductor that connects between the first conductor layer and the first ground layer;
a second short-circuit section made of a strip-shaped conductor that connects between the second conductor layer and the first ground layer; and
a capacitor connected between the first conductor layer and the ground layer,
wherein, the first conductor layer serves as a first antenna.

2. The antenna unit of claim 1, wherein
the first conductor layer is disposed on an insulating resin-made second substrate,
the second conductor layer is disposed on an insulating resin-made third substrate,
the first feeder section and the first short-circuit section are disposed along an outer edge of a side surface of the second substrate,
the second short-circuit section is disposed along an outer edge of a side surface of the third substrate, and the second substrate and the third substrate are fixed to the first substrate.

3. The antenna unit of claim 1, wherein the capacitor is disposed at any one of
i) a position with a longest interval from the first feeder section; and
ii) in proximity of the most distant position, with respect to the second substrate.

4. The antenna unit of claim 1, wherein the first feeder section is disposed close to the first short-circuit section.

5. The antenna unit of claim 1, wherein the first feeder section is disposed any one of
i) at a position identical to the second short-circuit section; and
ii) in proximity of the second short-circuit section.

6. The antenna unit of claim 1, wherein the first short-circuit section is differently located from the second short-circuit section.

7. The antenna unit of claim 1, wherein the opening is shaped into a quadrilateral, the capacitor and the first feeder section are disposed so as to have generally diagonal positions on the quadrilateral-shaped opening.

8. The antenna unit of claim 1, wherein the first substrate has a short-circuit through-hole charged with conductive material, and the first ground layer and the second short-circuit section are connected by the short-circuit through-hole.

9. The antenna unit of claim 1, wherein a first radio frequency circuit connecting to the first feeder section is disposed on the first surface other than an area corresponding to the opening.

10. The antenna unit of claim 1, wherein a second ground layer and a second radio frequency circuit mounted thereon are disposed on the second surface other than corresponding to the rear surface of the opening, the first radio frequency circuit and the second radio frequency circuit are connected by a conductive through-hole.

11. The antenna unit of claim 1 further includes a generally linear conductor element; and a second feeder section disposed on the first surface so as to avoid the opening, and wherein the generally linear conductor element and the first radio frequency circuit are connected at the second feeder section.

12. The antenna unit of claim 1, wherein the linear conductor element serves as a second antenna.

13. The antenna unit of claim 11 further includes a selector switch on the first surface other than the area corresponding to the opening, and wherein the selector switch is disposed so as to connect to the second feeder section, the first feeder section, and the radio frequency circuits.

14. The antenna unit of claim 13, wherein the selector switch switches between the first antenna and the second antenna.

15. The antenna unit of claim 1, wherein a mechanical switch is disposed on the first substrate on the first surface other than an area corresponding to the opening.

16. A manufacturing method of an antenna unit formed of a) an insulating first substrate having a first surface and a second surface that is disposed on an opposite side of the first surface; b) a conductive first ground layer with an opening having a determined shape disposed on the first surface of the first substrate; c) a first conductor layer that is shaped generally identical to the opening and is oppositely spaced to the first surface at the opening; d) a second conductor layer that is shaped generally identical to the opening and is oppositely spaced to the second surface on a side of a rear surface of the opening; e) a first feeder section made of a strip-shaped conductor that connects to the first conductor layer; f) a first short-circuit section made of a strip-shaped conductor that connects between the first conductor layer and the first ground layer; g) a second short-circuit section made of a strip-shaped conductor that connects between the second conductor layer and the first ground layer; and h) a capacitor connected between the first conductor layer and the ground layer,
method comprising the step of adjusting the first feeder section, the first short-circuit section, and the second short-circuit section for optimized arrangement.

17. The manufacturing method of the antenna unit of claim 16 further including the steps of:
forming the first feeder section and the first short-circuit section, with conductive material, on a side surface of an insulating resin-made second substrate having the first conductor layer;
forming the second short-circuit section, with conductive material, on a side surface of an insulating resin-made third substrate having the second conductor layer; and
attaching the second substrate and the third substrate to the first substrate.

18. The manufacturing method of the antenna unit of claim 17, wherein the adjusting step includes a sub step in which a most preferable third substrate with desirable antenna characteristics is selected among a plurality of the third substrates each of which has the differently positioned second short-circuit section.

19. The manufacturing method of the antenna unit of claim 17, wherein the adjusting step includes another sub step in which a most preferable second substrate with desirable antenna characteristics is selected among a plurality of the second substrates each of which has a different interval between the first short-circuit section and the first feeder section.
